(19) United States
(12) Patent Application Publication
(10) Pub. No.: US 2003/0184234 A1
(43) Pub. Date: Oct. 2, 2003

(54) Electrode device for a plasma processing system

(75) Inventors: Chia-Yuan Hsu, Tainan (TW); Yong-Hau Foo, Kaohsiung (TW); Jin-Fong Yen, Tainan (TW); Yeou-Yih Tsai, Tainan (TW); Chong-Ren Maa, Taipei (TW)

Correspondence Address: SENNIGER POWERS LEAVITT AND ROEDEL, ONE METROPOLITAN SQUARE, 16TH FLOOR, ST LOUIS, MO, 63102, US

(73) Assignees: Nano Electronics and Micro System Technologies, Inc.; S&S Laminates Corporation

(21) Appl. No.: 10/294,312

(22) Filed: Nov. 13, 2002

(30) Foreign Application Priority Data
Apr. 2, 2002 (TW) 091204226

(51) Int. Cl. H01J 7/24

(52) U.S. Cl. 315/111.21; 315/111.51

(57) ABSTRACT

An electrode device for a plasma processing system is presented. The electrode device is installed in a chamber of the plasma processing system. The electrode device comprises a plurality of electrode assemblies. Each electrode assembly has at least one first electrode and at least one second electrode. The first electrode is connected to a first output of a power supply, and the second electrode, connected to a second output of the power supply. Each electrode assembly is spaced apart from each other so as to generate plasma in the chamber. The electrode assembly comprises at least two electrodes (the first electrode and the second electrode) with shorter distance between the electrodes, and the type of the power supply can be altered to increase the electric field intensity, the hollow cathode effect, plasma density and uniformity. The electrode device can raise the efficiency in processing the object, and increase the uniformity of the electric field and upgrade the quality of the object.

### BACKGROUND OF THE INVENTION

1. Field of the Invention

The present invention relates to an electrode device, more particularly, to an electrode device for a plasma processing system.

2. Description of the Related Art

Referring to FIG. 1, an electrode device 11 is installed in a chamber of a plasma processing system so as to generate plasma for processing a surface of an object 12 in the chamber. The electrode device 11 comprises: a first electrode plate 111 and a second electrode plate 112. The first electrode 111 is connected to a positive terminal of a DC power supply. The second 112 is connected to a negative terminal of the DC power supply, whereby, an electric field is generated by the first electrode and the second electrode.

However, because the object 12 is mounted between the first electrode plate 111 and the second electrode plate 112 and is in parallel to the first electrode plate 111 and the second electrode plate 112, an electric field intensity on the middle section between the first electrode plate 111 and the second electrode plate 112 is smaller than that on the periphery section between the first electrode plate 111 and the second electrode plate 112. Besides, the electric field intensity on the periphery section is influenced by discharge between the electrode plates and the chamber so that the electric field intensity on the periphery section is increased to cause un-uniform electric field.

Referring to FIG. 2, another electrode device 21 of conventional plasma processing system is connected to a medium frequency power supply to solve the problem of un-uniform electric field. The electrode device 21 comprises: a first electrode plate 211 and a second electrode plate 212. The first electrode plate 211 is connected to a first output 22 of the medium frequency power supply, and the second electrode plate 212 is connected to a second output 23 of the power supply. Therefore, an electric field is generated by the first electrode plate 211 and the second electrode plate 212.

As shown in FIG. 2, the phase of the first output 22 is different from that of the second output 23 so that the electric field intensity is increased. If the phase difference between the first output 22 and the second output 23 is 180 degree, the voltage difference between the two electrode plates 211 and 212 are double voltages from each output. Therefore, the electric field intensity between the two electrode plates is high. For the periphery section of the electrode device, because the chamber is connected to ground, the voltage difference between the electrode device 21 and the chamber is lower than that between the two electrode plates 211 and 212. Compared to the high electric field intensity between the two electrode plates 211 and 212, the influence of the low electric field intensity between the electrode device 21 and the chamber can be decreased.

Furthermore, the electrode device 11 in FIG. 1 and the electrode device 21 in FIG. 2 are capacitor type electrodes for generating plasma, the plasma density by the conventional electrode device is low. The efficiency for processing the object is not good and the processing time is long. The quality on the surface of the object is bad.

Therefore, it is desirable to provide a novel and creative electrode device for a plasma processing system to overcome the above problems.

### SUMMARY OF THE INVENTION

One objective of the present invention is to provide an electrode device for a plasma processing system. The electrode device is installed in a chamber of the plasma processing system. The electrode device comprises a plurality of electrode assemblies. Each electrode assembly has at least one first electrode and at least one second electrode. The first electrode is connected to a first output of a power supply, and the second electrode, connected to a second output of the power supply. Each electrode assembly is spaced apart from each other so as to generate plasma in the chamber.

According to the invention, the electrode assembly comprises at least two electrodes (the first electrode and the second electrode) to shorten the distance between the electrodes, and the phase of the power supply can be altered to increase the electric field intensity, the hollow cathode effect, plasma density and uniformity. If the electrodes of the electrode device are high plasma density type, for example inductively coupled type electrode and hollow cathode type electrode, and the electrode device comprises at least two electrodes, the electrode device will have at least two high plasma density sources to increase the plasma density and uniformity and upgrade the quality of the object.

Another objective of the present invention is to provide a plasma processing system. The plasma processing system comprises: a chamber, a pumping device, a power supply and an electrode device. The pumping device is used for pumping air of the chamber. The power supply has a first output and a second output. The electrode device is installed in the chamber. The electrode device comprises a plurality of electrode assemblies. Each electrode assembly has at least one first electrode and at least one second electrode. The first electrode is connected to a first output of a power supply, and the second electrode, connected to a second output of the power supply. Each electrode assembly is spaced apart from each other so as to generate plasma in the chamber.

### BRIEF DESCRIPTION OF THE DRAWINGS

FIG. 1 shows an electrode device of the conventional plasma processing system.

FIG. 2 shows another electrode device of the conventional plasma processing system.

FIG. 3 is a block diagram illustrating a plasma processing system according to the present invention.

FIG. 4 shows an electrode device according to the first embodiment of the invention.

FIG. 5 shows an electrode device according to the second embodiment of the invention.

FIG. 6 shows an electrode device according to the third embodiment of the invention.

FIG. 7 shows an electrode device according to the fourth embodiment of the invention.

FIG. 8 shows an electrode device according to the fifth embodiment of the invention.

FIG. 9 shows an electrode device according to the sixth embodiment of the invention.

FIG. 10 shows an electrode device according to the seventh embodiment of the invention.

FIG. 11 shows an electrode device according to the eighth embodiment of the invention.

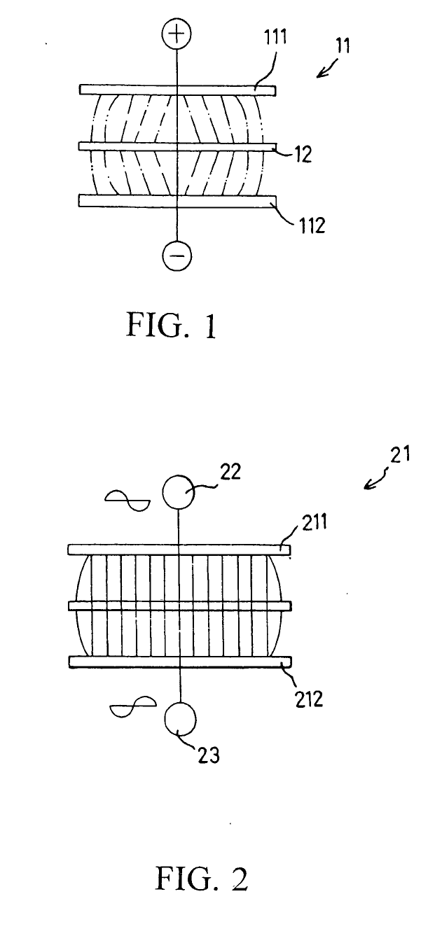

### DETAILED DESCRIPTION OF THE INVENTION

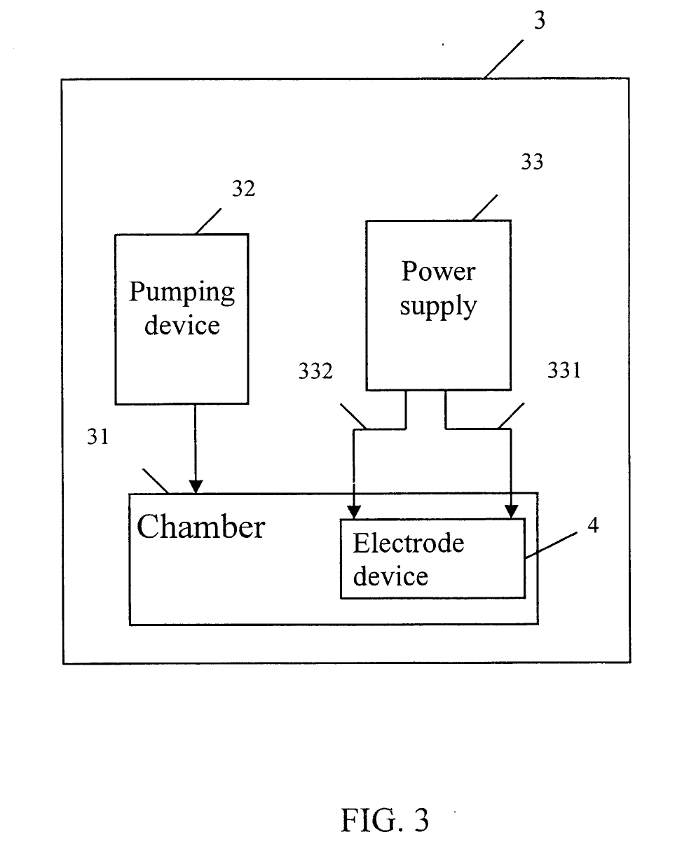

Referring to FIG. 3, according to the invention, a plasma processing system 3 comprises: a chamber 31, a pumping device 32, a power supply 33 and an electrode device 4. The plasma processing system 3 generates plasma to process a surface of objects in the chamber 31. The pumping device 32 utilizes vacuum pumps for pumping air of the chamber.

The power supply 33 is provided to supply the power of the electrode device 4. The plasma processing system 3 can have two or more power supplies. The power supply 33 has a first output 331 and a second output 332. The power supply 33 may be a DC power supply, a DC pulse power supply, a low frequency power supply, a medium frequency power supply or a high frequency power supply. The phase degree between the first output 331 and the second output 332 may be 0 degree to 180 degrees. If the first output 331 has the same phase degree as that of the second output 332, the plasma density will be increased. If the phase degree between the first output 331 and the second output 332 is 180 degrees, the electric field will be increased.

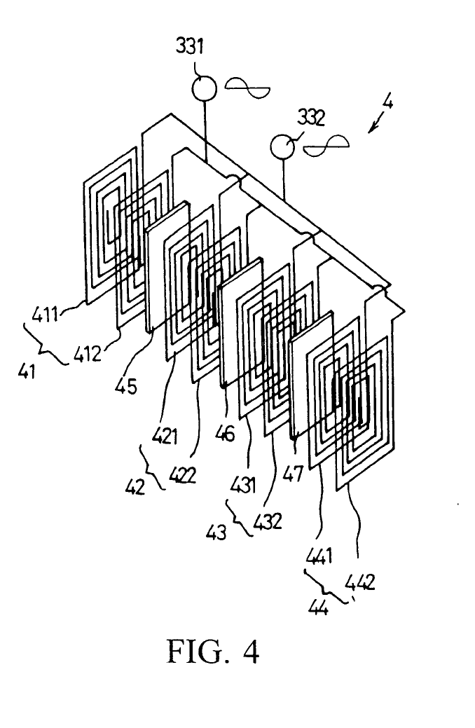

Referring to FIG. 4, according to the first embodiment of the invention, the electrode device 4 comprises: a first electrode 411, a second electrode 412, a third electrode 421, a fourth electrode 422, a fifth electrode 431, a six electrode 432, a seven electrode 441 and an eighth 442. The first electrode 411 is spaced apart from the second electrode 412, and the first electrode 411 and the second electrode 412 constitute a first electrode assembly 41. The third electrode 421 is spaced apart from the fourth electrode 422, and the third electrode 421 and the fourth electrode 422 constitute a second electrode assembly 42. The fifth electrode 431 is spaced apart from the sixth electrode 432, and the fifth electrode 431 and the sixth electrode 432 constitute a third electrode assembly 43. The seventh electrode 441 is spaced apart from the eighth electrode 442, and the seventh electrode 441 and the eighth electrode 442 constitute a fourth electrode assembly 44.

A first object 45 is installed between the first electrode assembly 41 and the second electrode assembly 42. A second object 46 is installed between the second electrode assembly 42 and the third electrode assembly 43. A third object 47 is installed between the third electrode assembly 43 and the fourth electrode assembly 44. If the space in the chamber is large enough to be installed with more electrodes and more objects, the plasma processing system will be able to perform the processing on the surface of more objects. Besides, if needed, an electrode device can comprise three electrodes, four electrodes or more electrodes.

According to the invention, two electrodes constitute an electrode assembly, and the object is mounted between two adjacent electrode assemblies. Such electrode configuration can shorten the distance between two electrodes of the electrode assembly so as to increase the electric field intensity, plasma density and uniformity. If two electrodes of the electrode assembly are connected to the power supply with the same phase degree, two electrodes will form the hollow cathode effect and the plasma density will be increased. If two electrodes of the electrode assembly are connected to the power supply with 180 phase degrees, the electric field will be increased. If the electrodes of the electrode device are high plasma density type, for example inductively coupled type electrode and hollow cathode type electrode, and the electrode device comprises at least two electrodes, the electrode device will have at least two high plasma density source to increase the plasma density and the uniformity and upgrade the quality of the object.

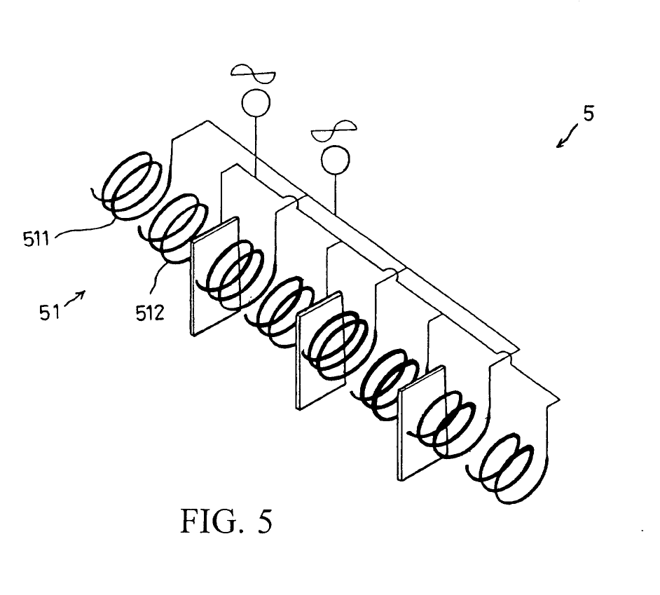

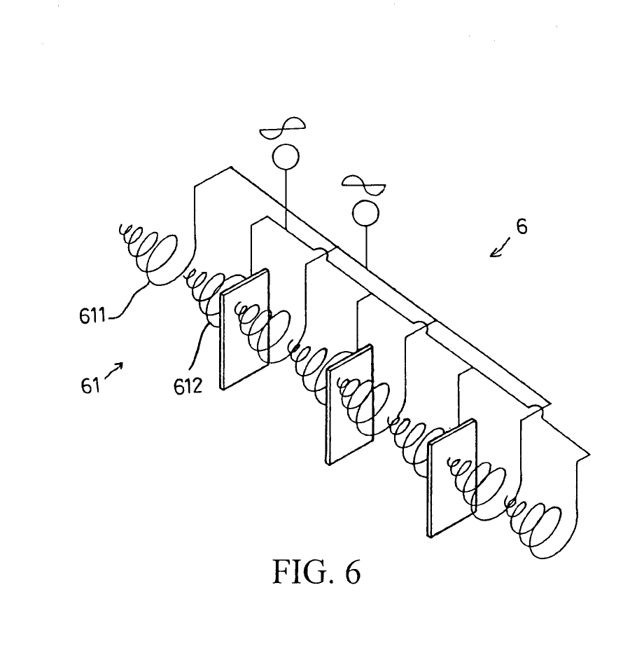

According to the first embodiment of the invention, the first electrode 411 and the second electrode 412 are configured to coil shape of inductively coupled type electrode, and the coil shape of the first electrode 411 and the second electrode 412 may be rectangle, circle, oval or of other shape. Referring to FIG. 5, it shows an electrode device 5 according to the second embodiment of the invention. Electrodes 511 and 512 of the electrode device 5 are configured to spiral shape of inductively coupled type electrode, and form an electrode assembly 51. Referring to FIG. 6, it shows an electrode device 6 according to the third embodiment of the invention. An electrode assembly 61 of the electrode device 6 comprises two spiral electrodes 611 and 612. The diameter of the electrodes 611 and 612 may gradually be increased or decreased.

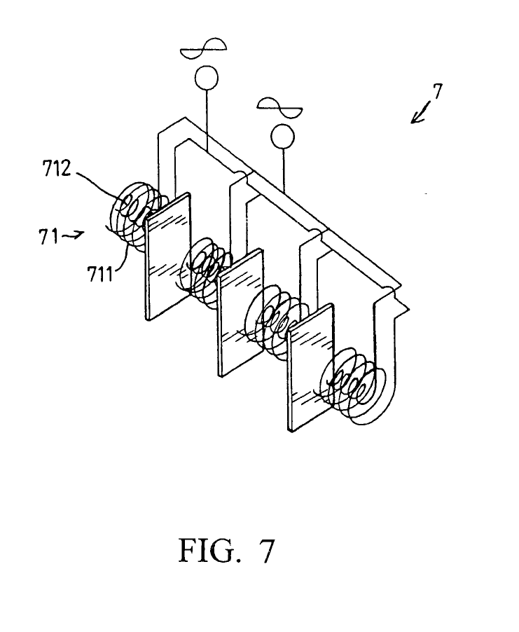

Referring to FIG. 7, according to the fourth embodiment of the invention, an electrode assembly 71 of an electrode device 7 comprises two spiral electrodes 711 and 712. The diameter of the spiral first electrode 711 is larger than that of the spiral second electrode 712 so that the spiral second electrode 712 can be mounted in the spiral first electrode 711. Therefore, to save the space and to shorten the distance between electrodes, the electrodes are configured to different diameters so as to increase the electric field intensity and plasma density.

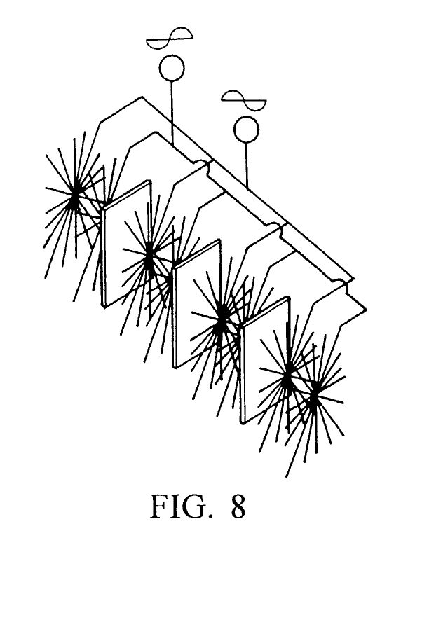

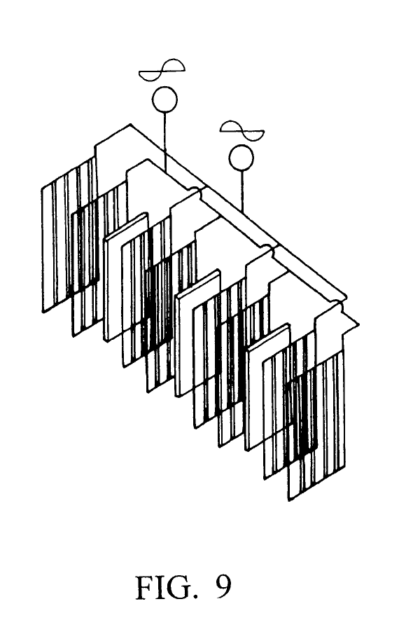

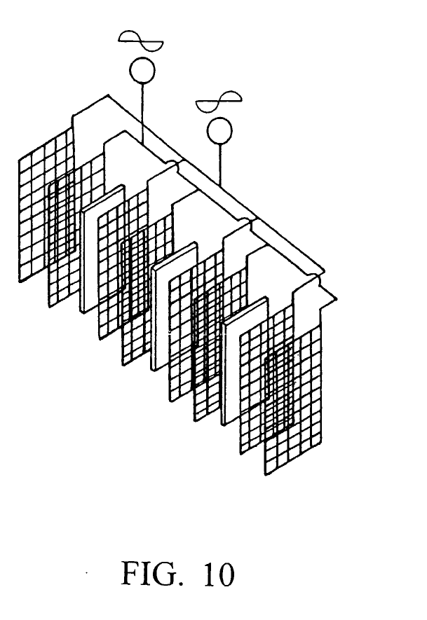

Referring to FIG. 8, according to the fifth embodiment of the invention, electrodes of an electrode device are configured to radial shape of inductively coupled type electrodes, and the electrodes are spaced apart from each other to define a distance. Referring to FIG. 9, according to the sixth embodiment of the invention, electrodes of an electrode device are configured to fence shape of inductively coupled type electrodes, and the electrodes are spaced apart from each other to define a distance. Referring to FIG. 10, according to the seventh embodiment of the invention, electrodes of an electrode device are configured to net shape of inductively coupled type electrodes, and the electrodes are spaced apart from each other to define a distance.

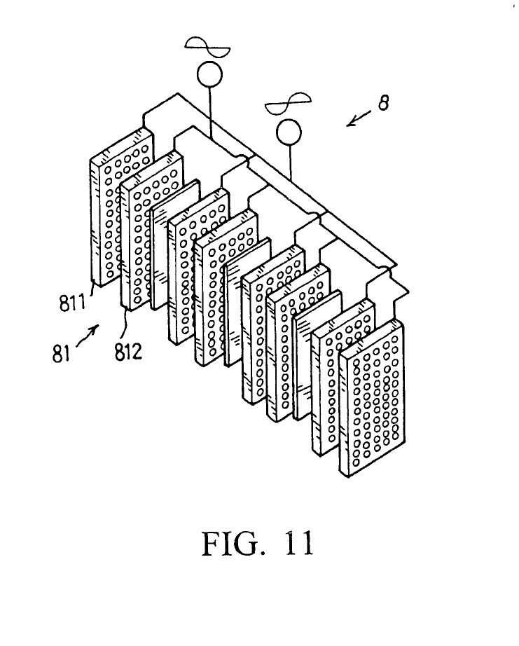

Referring to FIG. 11, according to the eighth embodiment of the invention, a first electrode 811 and a second electrode 812 of an electrode device 8 are configured to hollow cathode type electrodes, and form an electrode assembly 81. The electrodes are spaced apart from each other to define a distance. In the eighth embodiment, not only each electrode forms hollow cathode effect, but also the first electrode 811 and the second electrode 812 form hollow cathode effect to further increase electric field intensity and plasma density.

Furthermore, the electrode device further comprises at least two magnets for inducing a magnetic field in order to increase plasma density and uniformity. The magnetic field may be in parallel to an electric field from the electrodes, or be vertical to the electric field. The magnets may be magnetic irons or magnetic coils.

The chamber can be heated by a heating device to raise the temperature of the system to facilitate the process of chemical reaction. The object, substrate or sample in the chamber can be grounding, non-grounging, floating or biasing. The power supply for providing bias on the object may be a DC power supply, a DC pulse power supply, a low frequency power supply, a medium frequency power supply or a high frequency power supply.

The plasma processing system utilizes the electrode device to generate plasma in the chamber, and the electrodes of the electrode device will have high heat. Therefore, there is coolant in the electrodes of the electrode device for cooling the electrodes. However, if the electrodes do not have very high heat, the coolant will not be needed for cooling the electrodes.

While an embodiment of the present invention is illustrated and described, various modifications and improvements can be made by persons skilled in the art. The embodiment of the present invention is therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. An electrode device for a plasma processing system, the electrode device installed in a chamber of the plasma processing system, the electrode device comprising:
a plurality of electrode assemblies, each electrode assembly having at least one first electrode and at least one second electrode, the first electrode connected to a first output of a power supply, the second electrode connected to a second output of the power supply, each electrode assembly spaced apart from each other so as to generate plasma in the chamber.

2. The electrode device as claimed in claim 1, wherein the first electrode and the second electrode are configured to coil shape of inductively coupled plasma type electrodes, and the first electrode is spaced apart from the second electrode to define a distance.

3. The electrode device as claimed in claim 1, wherein the first electrode and the second electrode are configured to spiral shape of inductively coupled plasma type electrodes.

4. The electrode device as claimed in claim 3, wherein an inner diameter of the spiral first electrode is larger than that of the spiral second electrode so that the spiral second electrode can be installed in the spiral first electrode.

5. The electrode device as claimed in claim 1, wherein the first electrode and the second electrode are configured to radial shape of inductively coupled type electrodes, and the first electrode is spaced apart from the second electrode to define a distance.

6. The electrode device as claimed in claim 1, wherein the first electrode and the second electrode are configured to fence shape of inductively coupled type electrodes, and the first electrode is spaced apart from the second electrode to define a distance.

7. The electrode device as claimed in claim 1, wherein the first electrode and the second electrode are configured to net shape of inductively coupled type electrodes, and the first electrode is spaced apart from the second electrode to define a distance.

8. The electrode device as claimed in claim 1, wherein the first electrode and the second electrode are hollow cathode type electrodes, and the first electrode is spaced apart from the second electrode to define a distance.

9. The electrode device as claimed in claim 1, further comprising at least two magnets for inducing a magnetic field being in parallel to an electric field from the first electrode and the second electrode.

10. The electrode device as claimed in claim 1, further comprising at least two magnets for inducing a magnetic field being vertical to an electric field from the first electrode and the second electrode.

11. The electrode device as claimed in claim 9 or 10, wherein the magnets are magnetic irons.

12. The electrode device as claimed in claim 9 or 10, wherein the magnets are magnetic coils.

13. A plasma processing system, comprising:
a chamber;
a pumping device for pumping air of the chamber;
a power supply having a first output and a second output;
an electrode device installed in the chamber, the electrode device comprising:
a plurality of electrode assemblies, each electrode assembly having at least one first electrode and at least one second electrode, the first electrode connected to the first output of the power supply, the second electrode connected to the second output of the power supply, each electrode assembly spaced apart from each other so as to generate plasma in the chamber.

14. The electrode device as claimed in claim 13, further comprising at least two magnets for inducing a magnetic field being in parallel to an electric field from the first electrode and the second electrode.

15. The electrode device as claimed in claim 13, further comprising at least two magnets for inducing a magnetic field being vertical to an electric field from the first electrode and the second electrode.

16. The electrode device as claimed in claim 14 or 15, wherein the magnets are magnetic irons.

17. The electrode device as claimed in claim 14 or 15, wherein the magnets are magnetic coils.
